(19) United States
(12) Patent Application Publication
(10) Pub. No.: US 2016/0187958 A1
(43) Pub. Date: Jun. 30, 2016

(54) TECHNIQUES FOR MANAGING POWER AND PERFORMANCE FOR A NETWORKING DEVICE

(71) Applicant: INTEL CORPORATION, Santa Clara, CA (US)

(72) Inventors: REN WANG, Portland, OR (US); CHRISTIAN MACIOCCO, Portland, OR (US); PATRICK CONNOR, Portland, OR (US); DINESH KUMAR, Beaverton, OR (US); NRUPAL JANI, Hillsboro, OR (US); DANIEL DAHLE, Wilsonville, OR (US); SAMEH GOBRIEL, Hillsboro, OR (US)

(73) Assignee: INTEL CORPORATION, Santa Clara, CA (US)

(21) Appl. No.: 14/582,993

(22) Filed: Dec. 24, 2014

(51) Int. Cl. G06F 1/32; G06F 13/42; G06F 13/40

(52) U.S. Cl. CPC G06F 1/3287; G06F 1/3293; G06F 13/4022; G06F 13/4282

(57) ABSTRACT

Various embodiments are generally directed to an apparatus, method and other techniques to create an idle period for a processing unit and a switching circuit by buffering one or more packets in a buffer for one or more input/output (I/O) ports. Embodiments may include causing the processing unit and/or the switching circuit to operate in a lower power state during the idle period and causing the processing unit and/or the switching circuit to exit the lower power state by communicating one or more out-of-band messages to the processing unit and/or the switching circuit.

### TECHNICAL FIELD

Embodiments described herein generally relate techniques for power and performance management of a networking device.

### BACKGROUND

Modern communication networks comprise nodes, such as routers, switches, bridges, and other devices, that transport data through the networks. Over the years, the networks have become increasingly complex, leading to interwoven webs of network nodes. As a result, node vendors have struggled to customize, optimize, and improve the performance of the nodes. Networks have not traditionally been programmable entities using instead specialized equipment such as application specific integrated circuits (ASICs). Although some programming frameworks may be used to configure networks, the intelligence has always been external to the network, and not an intrinsic part of the network itself.

### BRIEF DESCRIPTION OF THE DRAWINGS

FIG. 1 illustrates an embodiment of a computing system to process packets.

FIG. 2 illustrates another embodiment of a computing system to process packets.

FIG. 3 illustrate embodiments of two timing diagrams.

FIGS. 4A/4B illustrate embodiments of a computing system to process packets.

FIG. 5 illustrates an embodiment of a first logic flow diagram.

FIG. 6 illustrates an embodiment of a second logic flow diagram.

FIG. 7 illustrates an embodiment of a third logic flow diagram.

FIG. 8 illustrates an embodiment of a computing system.

FIG. 9 illustrates an exemplary embodiment of a computing architecture.

### DETAILED DESCRIPTION

Various embodiments are generally directed to an apparatus, system and method to improving power consumption and information flow through one or more computing devices, such as a network computing device. More specifically, embodiments may be directed to enabling idle periods between processing of packets, such that one or more components of a computing device can enter and remain in a lower power (and lower frequency) operational state for longer periods of time. Moreover, these embodiments may include notifying input/output (I/O) ports of a components desire to enter a lower power state to enable buffering of packets in one or more buffers. These packets may be buffered and released in a coordinated fashion to create longer idle periods. Thus, significant power savings may be realized using these buffering techniques.

Further, embodiments may also be directed to intelligently communicating with the components so that they exit the lower power state and enter an operating state to process information in a coordinated fashion and prior to packets being released for processing. For example, one or more messages, such as out-of-band messages, can be communicated to the components indicating that they need to exit the lower power state and to be ready to process packets. These messages may be communicated prior to the end of dynamic memory addressing (DMA) and the issuance of a DMA interrupt by the I/O ports.

Additionally, embodiments may be directed to controlling the flow of the packets through the I/O ports. For example, packets may be redirected from a heavily utilized I/O port to a lower utilized I/O port for processing in order to optimize buffer and processing resources for the heavily utilized I/O port. Even though, in some instances, the packets may be communicated on an I/O port that is not the shortest path to its destination, the packets may arrive and be processed sooner due to latency issues on the heavily utilized I/O ports. These and other details will become more apparent with the following description.

Various embodiments also relate to an apparatus or systems for performing these operations. This apparatus may be specially constructed for the required purpose or it may include a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

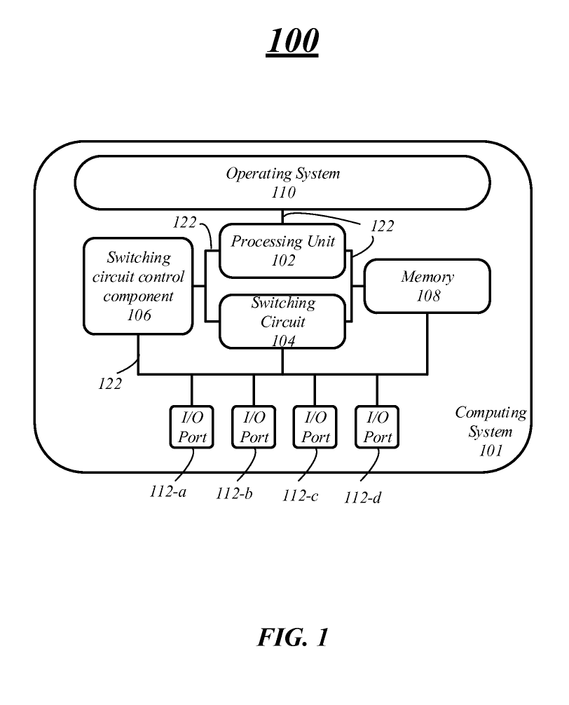

FIG. 1 illustrates an exemplary embodiment of a computing system 101 to process information, perform switching operations, and perform power and performance management to conserve energy and power consumption. In some embodiments, the computing system 101 includes a processing unit 102, a switching circuit 104, a switching circuit control component 106, and a memory 108. Further, the computing system 101 may include one or more I/O ports 112 to send and receive information in one or more packets.

The computing system 101 may be any type of computing device including, but not limited to, a networking device, a network switch, a multilayer switch, a router, a networking hub, a switching hub, a bridging hub, a media access control (MAC) bridge, a packet switching device, a multi-port network bridge, or any other type of device that processes packets. For example, the computing system 101 may be a computing device, such as a computer, a desktop computer, a laptop, a tablet, a telephone including a cellular telephones, a smart telephone, a personal digital assistant, a server, a rack mounted server, a blade server, or any other type of server. In particular embodiments, the computing system 101 may be a software switch or software/hardware hybrid switch, such as a software-defined (SDN) networking switch which may implement network functions virtualization (NFV) to virtualize various aspects of network processing. Various embodiments are not limited in this manner.

In embodiments, the computing system 101 includes one or more processing units 102 and a switching circuit 104. A processing unit 102 of may be any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing unit 102 may be connected to and communicate with the switching circuit 104, the switching circuit control component 106 and the memory 108 via one or more interconnects 122, which may be any type of trace, bus, and so forth. For example, interconnects 122 may at least be partially implemented as a system management bus (SMBus), Inter-Integrated Circuit (I2C) bus, or any other type of bus and may communicated information in one or more out-of-band messages. Various embodiments are not limited in this manner.

The switching circuit 104 which may include any type of switching circuitry such as a switching fabric, a networking crossbar such as a software crossbar, a packet switch circuit, etc. In some embodiments, the switching circuit 104 may be at least partially virtualized and at least partially implemented in software. Various embodiments are not limited in this manner.

In embodiments, the switching circuit 104 directs the flow of packets communicated by the I/O ports 112. For example, the switching circuit 104 may direct the flow of one or more packets received at I/O port 112-a to another I/O port, such as I/O port 112-b, I/O port 112-c or I/O port 112-d. In another example, the switching circuit 104 may direct the flow of one or more packets received at I/O port 112-b to another I/O port, such as I/O port 112-a, I/O port 112-c or I/O port 112-d. Various embodiments are not limited in this manner, and the switching circuit 104 may direct the flow of one or more packets received by any one of the I/O ports 112 to any of the I/O ports 112 for sending. In other words, packets can be received and sent on the same I/O port 112. An I/O port 112 may be any type of port to communicate information, including a network port, a physical port, a software I/O port, and so forth. In various embodiments, an I/O port 112 may include circuitry, such as a transceiver, to communicate information as one or more packets to a coupled device. Various embodiments are not limited in this manner.

In some embodiments, the switching circuit 104 may direct the flow of packets based on information in the packets. For example, a packet may include a target identification, an address, a port number, etc., and the switching circuit 104 may determine which I/O port 112 to send the packet to based on the identification. However, in some embodiments, the switching circuit 104 may direct packets based on information received from the switching circuit control component 106. For example, the switching circuit control component 106 may determine that an output port of one of the I/O ports 112 is over utilized or experiencing heavy traffic. In this case, the switching circuit control component 106 may instruct the switching circuit 104 to send lower priority packets intended for the over utilized I/O port 112 to another I/O port 112 that is less utilized. These and other details will become more apparent in the following description.

The switching circuit 104 may also operate in various operational states. For example, the switching circuit 104 may operate in a lower power state, a medium power state, or a higher power state. The frequency at which the switching circuit 104 may also be adjusted. Typically, lower power states operate at a lower frequency state, medium power states operate at a medium frequency state, and higher power states operate at a higher frequency state, for example. The switching circuit 104 may operate in any number of power states and frequency states and is not limited to three power states and/or three frequency states. The operational states may be monitored and controlled by the switching circuit control component 106.

The components of the computing system 101 including the processing unit 102 and switching circuit 104 may be coupled with one or more software layers including an operating system 110. For example, the processing unit 102 and the operating system 110 may communicate via a kernel using function calls, system calls, interrupts, and so forth. The operating system 110 may be implemented in software only, hardware only, or combination thereof, and can be used to manage components of the computing system 101, such as the processing unit 102, the switching circuit 104, the switching circuit control component 106, the memory 108, and so forth. Examples of an operating system include a Linux® based operating system, a Windows® operating system, an Apple® based operating system, and so forth.

In some embodiments, such as when the computing system 101 is an SDN networking switch, the operating system 110 may include one or more applications to manage and control the computing system 101. More specifically, the operating system 110 may include one or more SDN applications that can communicate network requirements and desired network behavior to the processing unit 102 and switching circuit 104, for example. Various embodiments are not limited in this manner.

In some embodiments, the computing system 101 may include a switching circuit control component 106 to manage various aspects of the computing system 101 including operational states for the processing unit 102 and the switching circuit 104, and controlling the flow of traffic through the I/O ports 112 via the switching circuit 104. The switching circuit control component 106 may be implemented in hardware only, software only, or combination thereof. Moreover and in some embodiments, the switching circuit control component 106 may be a standalone component or implemented as one or more portions of another component, such as the processing unit 102 and/or the switching circuit 104. In some embodiments, the switching circuit control component 106 may also be implemented as a SDN application when the computing system 101 is a SDN networking device, for example. Various embodiments are not limited in this manner.

In some embodiments, the switching circuit control component 106 may control and manage traffic flow on the I/O ports 112 to create idle periods such that the processing unit 102 and the switching circuit 104 can enter lower power and/or frequency operational states. Typically, the I/O ports receive and send packets at random intervals leaving little “down” time for the processing unit 102 and switching circuit 104 to enter lower power and/or frequency states. The switching circuit control component 106 can enable idle periods for the processing unit 102 and the switching circuit 104 by notifying the I/O ports 112 that the processing until 102 and/or switching circuit 104 desire to enter a lower power and/or frequency states. In response, the I/O ports 112 may utilize buffers to buffer packets to generate idle periods or periods of time when the processing unit 102 and/or the switching circuit 104 do not have to process packets and can enter the lower power and/or frequency states. Various embodiments are not limited to this example, and in some embodiments, the switching circuit control component 106 may instruct the I/O ports 112 to buffer packets for an amount of time.

In some embodiments, the switching circuit control component 106 may utilize optimized buffer flush/fill (OBFF) techniques to enable buffering of the packets on the I/O ports 112 to generate the idle periods. For example, the switching control component 106 may communicate information to the I/O ports 112 indicating that the processing unit 102 and the switching circuit 104 are about to enter a lower power state. The I/O ports 112 may use this information to group one or more packets in a buffer. The I/O ports 112 may release packets for processing by the processing unit 102 and switching circuit 104 in “bursts” and in a coordinated fashion such that the processing unit 102 and the switching circuit 104 can remain in a low power and/or frequency states for a longer period of time conserving more energy. This is just one example of coordinating and buffering packets for processing to extend and create longer idle periods. Other techniques may be contemplated.

In some embodiments, the switching circuit control component 106 may control and manage the operating states of the processing unit 102 and switching circuit 104, and the changing thereof, based on packet information received from the I/O ports 112. For example, the packet information can include a number of packets in each “burst” size and/or a priority of packets. Thus, the switching circuit control component 106 may determine when and for how long the processing unit 102 and/or switching circuit 104 can be in a lower power and/or frequency state based on a size of the packets in each burst. In another example, the switching circuit control component 106 may control how long the processing unit 102 and/or switching circuit 104 are in the lower power and frequency state based on the priority of the packets being buffered. Higher priority packets may need to be processed more frequently, and therefore, require shorter idle periods, for example.

Moreover, the switching circuit control component 106 may control the operating states of the processing unit 102 and/or switching circuit 104 to ensure that they are in the proper operating state to process information without latency and impacting performance. For example, the switching circuit control component 106 may use the packet information to put the processing unit 102 and/or switching circuit 104 into a higher power and/or frequency state prior to the completion of dynamic memory addressing (DMA) and before the I/O ports 112 issues an interrupt, such as a DMA interrupt to process the packets. By raising the processing unit 102 and/or the switching circuit 104 to the appropriate operating state, they will be ready to process packets in time.

The switching circuit control component 106 can also manage and control the flow of traffic of packets through each of the I/O ports 112 based on the packet information and throughput on the I/O ports 112. More specifically, the switching circuit control component 106 may enable load balancing techniques for the I/O ports 112 by diverting lower priority packets from I/O ports 112 experiencing heavy traffic to lower utilized I/O ports 112, for example. The switching circuit control component 106 may determine I/O port utilization, throughput, and priority of packets based on the packet information received from the I/O ports 112 and/or by monitoring the I/O ports 112.

Furthermore, by diverting lower priority packets from their intended I/O ports 112 to another I/O port 112, the heavily used I/O port 112 will be able to process higher priority packets in a timelier manner. Therefore, higher priority packets may still be communicated to the higher utilized I/O port 112. Moreover, the switching circuit control component 106 may direct or instruct the switching circuit 104 to direct packets intended for any one of the I/O ports 112 to any other I/O port 112 based on the packet information and/or I/O port utilization.

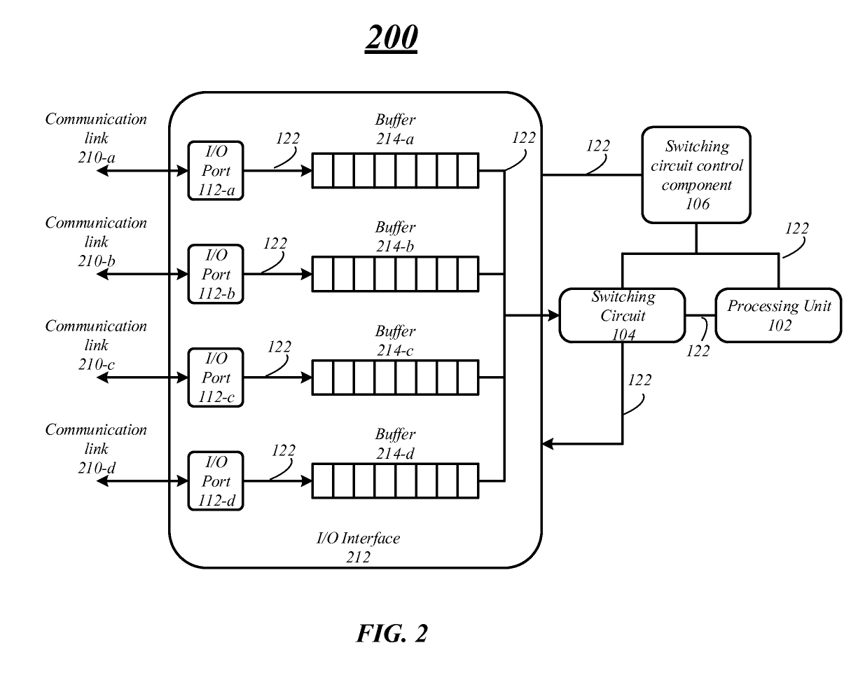

FIG. 2 illustrates an embodiments of a second computing system 200 to process packets and information. As illustrated in FIG. 2, each of the I/O ports 112 may communicate information over communication links 210 and can be coupled with or associated with a particular buffer 214. For example, I/O port 112-a may be associated with buffer 214-a, I/O port 112-b may be associated with buffer 214-b, I/O port 112-c may be associated with buffer 214-c, and I/O port 112-d may be associated with buffer 214-d. The I/O ports 112 and the buffers 214 along with other circuitry and memory may make up an I/O interface 212 for the computing system 200. However, various embodiments are not limited in this manner. In some embodiments the buffers 214 may not be part of the I/O interface 212, but may be allocated in memory 108, for example.

In embodiments, the I/O ports 112 may communicate information with coupled devices via the communication links 210 and may store incoming packets in an associated buffer 214 for further processing by the switching circuit 104 and the processing unit 102. As previously discussed, the switching circuit control component 106 may manage and control the buffering by the I/O ports 112 in the buffers 214, for example. More specifically and in one example, the switching circuit control component 102 may communicate with the I/O interface 212 such that one or more packets received on by the I/O ports 112 are buffered in buffers 214 and sent to the switching circuit 104 and processing unit 102 in bursts to create idle periods. These idle periods may be utilized by the switching circuit 104 and the processing unit 102 to operate in a lower power and/or frequency operational states. In some embodiments, the switching circuit control component 106 can use an OBFF technique to control the buffering of the packets and create the idle periods.

During active periods or when the switching circuit 104 and processing unit 102 are operating in a higher power and/or frequency states, the switching circuit control component 106 may also direct the flow of packets through the I/O ports 112. More specifically, the switching circuit control component 106 can implement load balancing techniques such that traffic on heavier I/O ports 112 is redirected to lower utilized I/O ports 112. For example, the switching circuit control component 106 may cause lower priority packets to be sent to lower utilized I/O ports 112 instead of their originally intended I/O port 112. The switching circuit control component 106 may perform the load balancing techniques by sending information to the switching circuit 104 to redirect packets.

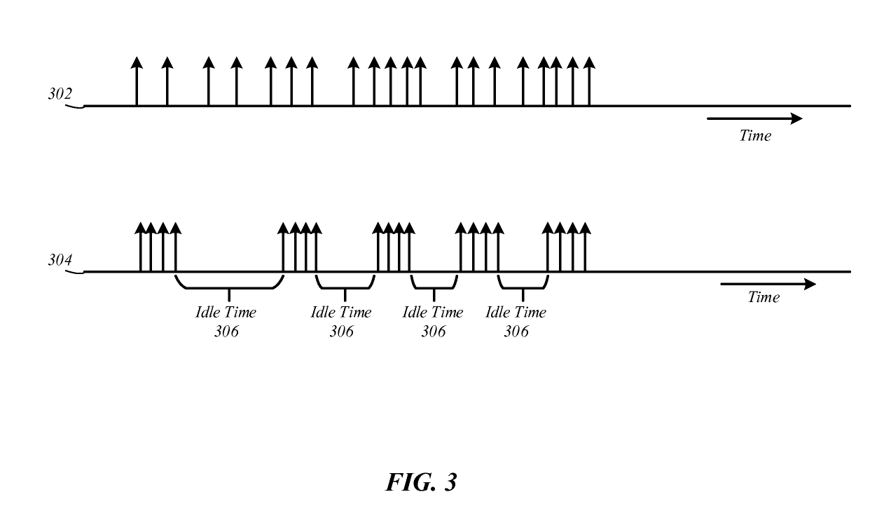

FIG. 3 illustrate embodiments of a first timing diagram 302 and a second timing diagram 304. The timing diagrams 302 and 304 may illustrate packets received by a computing system and processed with and without buffering of the packets to create idle periods. More specifically, timing diagram 302 illustrates packets, as arrows, received and processed by I/O ports 112 without buffering. Each arrow indicates when a packet is received and sent to a switching circuit 104 and/or a processing unit 102 for processing. Thus, in embodiments were buffering is not utilized to optimize burst periods, there is little time available for a switching circuit 104 and/or a processing unit 102 to be a lower power and/or frequency operational states. Thus, more power is consumed in these embodiments.

However, timing diagram 304 illustrates packets being buffered and grouped. As illustrated in timing diagram 304, the packets are processed and sent to a switching circuit 104 and/or processing unit 102 in bursts and idle times 306 are created between each of the bursts. Thus, in these embodiments a switching circuit 104 and/or a processing unit 102 may spend longer periods of time in a lower power and/or frequency operation states and power may be saved.

As mentioned, the buffering of the packets may be controlled by a switching circuit control component 106 which can implement an OBFF technique. For example, the switching control component 106 may communicate information to the I/O ports 112 indicating that the processing unit 102 and the switching circuit 104 are in a lower power and/or frequency states or desire to be in a lower power and/or frequency states. The I/O ports 112 may use this information to group or buffer one or more packets in a buffer. The I/O ports 112 may release packets for processing by the processing unit 102 and switching circuit 104 in “bursts” and in a coordinated fashion. OBFF is just one example of coordinating and buffering packets for processing to extend and create longer idle periods. Other techniques may be implemented.

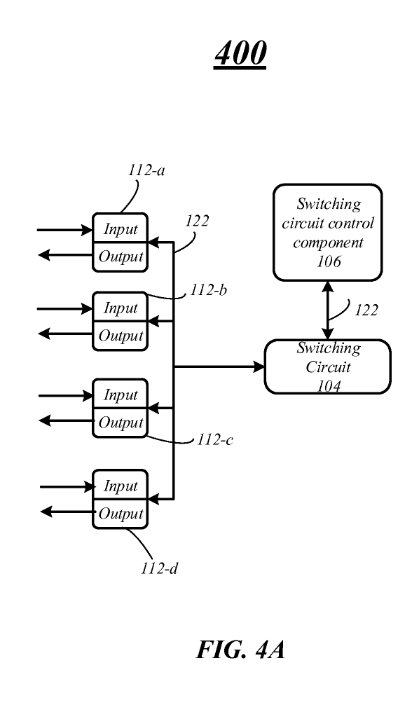

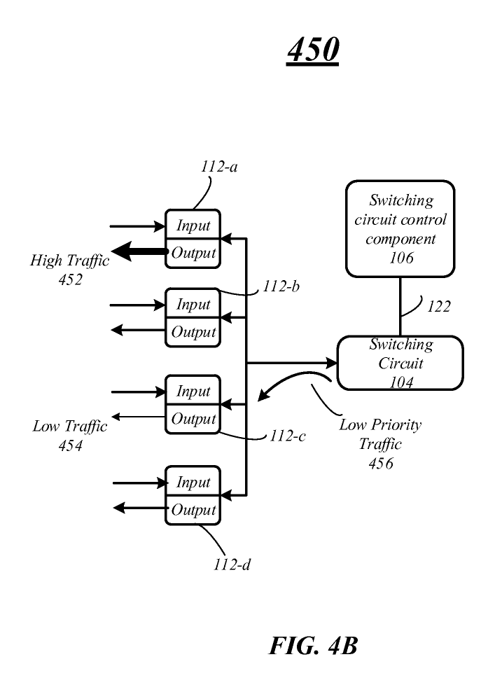

FIGS. 4A/4B illustrate embodiments of computing systems 400 and 450 processing packets of information. FIG. 4A illustrates the I/O ports 112-a through 112-d receiving and sending packets over a communication link 210, for example. As illustrated, the I/O ports 112 may include an input port and an output port. Information may be received as one or more packet over the input port and information may be sent as one or more packets over the output port.

The information processed by the I/O ports 112-a through 112-d may be processed by the switching circuit 104. For example, the switching circuit 104 may direct the flow of the packets to the appropriate target I/O port 112 based on a target address and/or a destination identification for each of the packets. Typically, the target I/O port 112 is the port providing the shortest path for the destination of the packet.

As previously mentioned, the switching circuit control component 106 may implement various load balancing techniques such that packets that are targeted for overloaded or heavily utilized ports 112 are sent to another, less utilized port 112. FIG. 4A illustrates a scenario in which the packets received and sent by the I/O ports 112 is occurring in a balanced manner.

However, FIG. 4B illustrates an embodiment where the output port of I/O port 112-a is over utilized and is experiencing heavy traffic 452. Information communicated over this I/O port 112-a may experience undesirable delays and may not meet quality of service (QoS) requirements for delivery of packets. In this case, the “shortest path” may not be the quickest route for the destination of the packets. Thus, embodiments may employ various techniques to load balance the I/O ports 112.

For example, the switching circuit control component 106 may direct lower priority traffic 456 originally destined for I/O port 112-a to one or more of the other ports, such as I/O port 112-c. As illustrated in FIG. 4B, the output port of I/O port 112-c is experiencing low traffic 454. Therefore, those packets taking a detour though I/O port 112-c may not experience as much latency throughput as the packets would if they were sent though I/O port 112-a experiencing heavy traffic 452. Additionally, the higher priority traffic original targeted for I/O port 112-a may be continued to be sent there, but will not experience any kind of latency delays due to the processing of the lower priority packets because of the redirection.

Various embodiments are not limited to the illustrated example of FIGS. 4A and 4B. The packets may be redirected in any manner to load balance the I/O ports 112. Furthermore, various embodiments may not be limited to the redirection on only output ports, as illustrated. In some embodiments, the flow of packets may be redirected on input ports as well. For example, the switching circuit control component 106 may communicate information to one or more sending devices, coupled to the ports 112, to send the packets on a path that is being less utilized. The switching circuit control component 106 may use various network mapping techniques to determine the path of “least resistance” that may be used by a sending device.

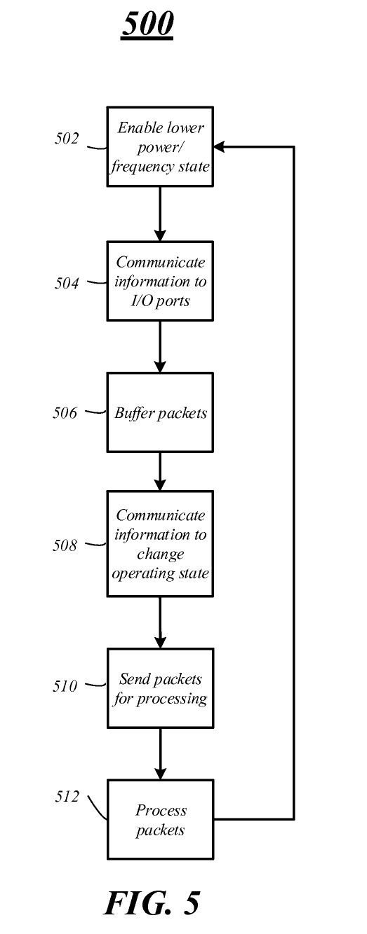

FIG. 5 illustrates an embodiment of a logic flow diagram 500. The logic flow 500 may be representative of some or all of the operations executed by one or more embodiments described herein. For example, the logic flow 500 may illustrate operations performed by one or more of the computing systems illustrated in FIGS. 1, 2, 4A and 4B. Various embodiments are not limited in this manner.

At block 502, the logic flow 500 may include enabling a lower power and/or frequency operational state for a processing unit 102 and/or switching circuit 104. More specifically, a switching circuit control component 106 may communicate information and/or instructions to a processing unit 102 and/or switching circuit 104 to enable them to change an operational state from a higher power and/or frequency operation states to a lower power and/or frequency states. The information may indicate to the processing unit 102 and switching circuit 104 that packets are being buffered by the I/O ports 112 and an idle period is created. In embodiments only the power may be changed, only the frequency may be changed, or both when changing the operational state. Similarly, the change may only be made for a processing unit, only a switching circuit, or both.

In some embodiments, the switching circuit control component 106 can communicate information to the I/O ports 112 indicating that the processing unit 102 and the switching circuit 104 are in a lower/frequency power state or desire to be in a lower/frequency power state at block 504. The I/O ports 112 may use this information to group or buffer one or more packets in a buffer at block 506. As previously mentioned, each I/O port 112 may be associated with a buffer 214 which is to be used to store the packets prior to sending them to the processing unit 102 and switching circuit 104. The I/O ports 112 may release packets for processing by the processing unit 102 and switching circuit 104 in “bursts” and in a coordinated fashion such that the processing unit 102 and the switching circuit 104 can remain in a low power/frequency state for a longer period of time.

At block 508, the switching circuit control component 106 may communicate information to the processing unit 102 and switching circuit 104 indicating that the idle period is about to end and the I/O packets 112 are going to send the packets. In some embodiments, the information may be sent as one or more out-of-bounds messages over a SMBus or a I2C bus. However, various embodiments are not limited in this manner.

At block 510, the I/O ports 112 may send the packets to the processing unit 102 and switching circuitry 104 for processing. For example, the packets may be processed and directed back to the I/O ports 112 for further communication over one or more communication links at block 512. Various embodiments are not limited in this manner and the packets may be processed in other means.

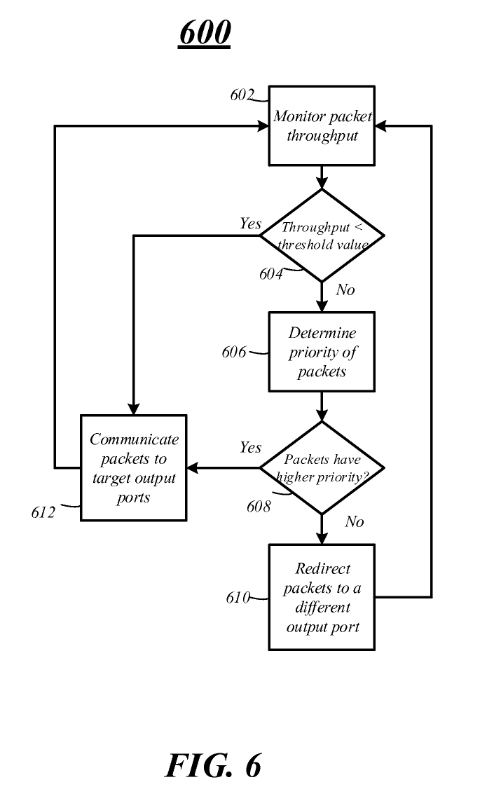

FIG. 6 illustrates an embodiment of a logic flow diagram 600. The logic flow 600 may be representative of some or all of the operations executed by one or more embodiments described herein. For example, the logic flow 600 may illustrate operations performed by one or more of the computing systems illustrated in FIGS. 1, 2, 4A and 4B. Various embodiments are not limited in this manner.

Logic flow 600 includes a number of blocks for monitoring and controlling packet processing, load balancing, and determining throughput. At block 602, a switching circuit control component 106 may monitor I/O ports 112 for throughput and the amount of traffic processed in bits/second, bytes/second, megabytes/second, and so forth. In some embodiments, the switching circuit control component 106 may determine whether an I/O port 112 is experience a high amount of traffic, a medium amount of traffic, or a low amount of traffic.

More specifically and in some embodiments, the switching circuit control component 106 may determine whether throughput on each of the I/O ports 112 is above a threshold value at decision block 604. The threshold value may also be an amount of information processed over time, such as bits/second, bytes/second, megabytes/second, and so forth. Moreover, the threshold value may be a determined value indicating that throughput may be too high and traffic processed through an I/O port 112 experiencing the high traffic amount may experience latency issues. The throughput for each of the I/O ports 112 may be compared to the threshold value to determine if it is less than, equal to, or more than the threshold value.

If at decision block 604, the switching circuit control component 106 determines the throughput is less than (or equal to) the threshold value for a particular I/O port 112, all of the output packets targeted for that particular I/O port 112 can be processed by the I/O port 112 at block 612. In another words, no redirection of traffic is needed because throughput is below (or equal) to the threshold value or an acceptable throughput. This determination may be made for each of the I/O ports 112.

If at decision block 604, the switching circuit control component 106 determines that the throughput is greater than the threshold value for a particular I/O port 112, the priority of the packets for that I/O port 112 may be determined at block 606. In some embodiments, the switching circuit control component 106 may determine the priority of the packets based on packet information received from the I/O ports 112. The packet information may be communicated to the switching circuit control component 106 as one or more messages, such as out-of-band messages over a SMBus or I2C bus. Various embodiments are not limited in this manner.

In some embodiments, at decision block 608 a determination may be made as to whether the packets have a higher priority level or a lower priority level. If the packets have a higher priority level, they may be sent to the targeted I/O port 112 at block 612 even though it is experience a high amount of traffic. However, if the packets are lower priority packets, they may be sent to different I/O port 112 at block 610 for processing. More specifically, the packets may be sent to an I/O port 112 experiencing a lower amount of traffic at block 610. Various embodiments are not limited in this manner.

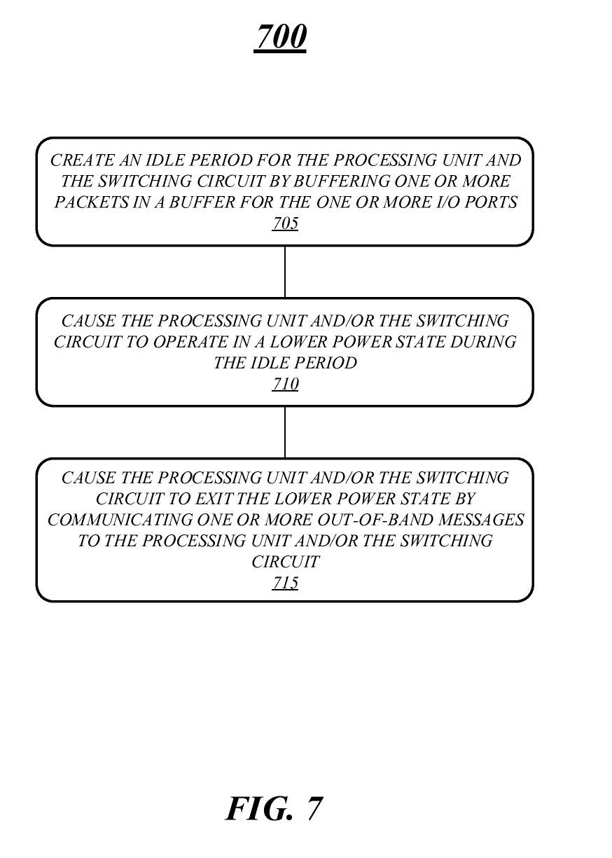

FIG. 7 illustrates an embodiment of a logic flow diagram 700. The logic flow 700 may be representative of some or all of the operations executed by one or more embodiments described herein. For example, the logic flow 700 may illustrate operations performed by one or more of the computing systems illustrated in FIGS. 1, 2, 4A and 4B. Various embodiments are not limited in this manner.

Logic flow 700 includes creating an idle period for the processing unit and the switching circuit by buffering one or more packets in a buffer for the one or more I/O ports at block 705. For example, switching circuit control circuit 106 can communicate information indicating that at least one of the processing unit 102 and switching circuit 104 are entering a lower power state or will be entering a lower power state. The information may cause the I/O ports 112 to buffer one or more packets such that they are communicated for processing in coordinated bursts. The time between the bursts may be an idle period in which the processing unit 102 and/or switching circuit 104 can enter or remain in a lower power/frequency operating state.

At block 710, the logic flow 700 can include causing the processing unit and/or the switching circuit to operate in a lower power state during the idle period. For example, the switching circuit control component 106 may communicate information to the processing unit 102, the switching circuit 104, or both, indicating that packets are to be buffered, in the processing of being buffered, and/or an idle period has been created. The information can cause the processing unit 102 and/or the switching circuit 104 to enter a lower power state. In some embodiments, the information may indicate a determined or estimated length of the idle period, which may be used to exit the lower power state. However, various embodiments are not limited in this manner and the components may receive an interrupt or message(s) to exit a lower power state.

More specifically and at block 715, the logic flow 700 may include causing the processing unit and/or the switching circuit to exit the lower power state by communicating one or more out-of-band messages to the processing unit and/or the switching circuit. In some embodiments, the out-of-band messages may indicate that the idle period is about to end and packets are to be processed. In one example, one or more out-of-band messages may be communicated prior to the completion of DMA buffering. Various embodiments are not limited in this manner and the messages may be communicated at any time to ensure that the processing unit 102 and the switching circuit 104 are in an operating state process the packets without causing latency issues.

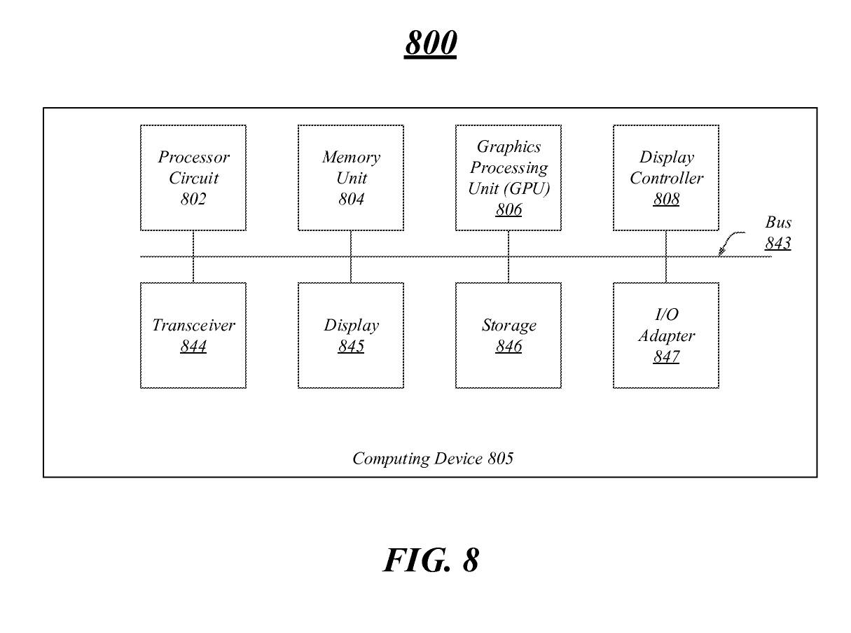

FIG. 8 illustrates one embodiment of a system 800. In various embodiments, system 800 may be representative of a system or architecture suitable for use with one or more embodiments described herein, such as computing system 101 and 200. The embodiments are not limited in this respect.

As shown in FIG. 8, system 800 may include multiple elements. One or more elements may be implemented using one or more circuits, components, registers, processors, software subroutines, modules, or any combination thereof, as desired for a given set of design or performance constraints. Although FIG. 8 shows a limited number of elements in a certain topology by way of example, it can be appreciated that more or less elements in any suitable topology may be used in system 800 as desired for a given implementation. The embodiments are not limited in this context.

In various embodiments, system 800 may include a computing device 805 which may be any type of computer or processing device including a personal computer, desktop computer, tablet computer, netbook computer, notebook computer, laptop computer, server, server farm, blade server, or any other type of server, and so forth.

In various embodiments, computing device 805 may include processor circuit 802. Processor circuit 802 may be implemented using any processor or logic device. The processing circuit 802 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 802 may be connected to and communicate with the other elements of the computing system via an interconnect 843, such as one or more buses, control lines, and data lines.

In one embodiment, computing device 805 may include a memory unit 804 to couple to processor circuit 802. Memory unit 804 may be coupled to processor circuit 802 via communications bus 843, or by a dedicated communications bus between processor circuit 802 and memory unit 804, as desired for a given implementation. Memory unit 804 may be implemented using any machine-readable or computer-readable media capable of storing data, including both volatile and non-volatile memory. In some embodiments, the machine-readable or computer-readable medium may include a non-transitory medium. The embodiments are not limited in this context. In some embodiments, memory 108 may be the same as memory unit 804.

Computing device 805 may include a graphics processing unit (GPU) 806, in various embodiments. The GPU 806 may include any processing unit, logic or circuitry optimized to perform graphics-related operations as well as the video decoder engines and the frame correlation engines. The GPU 806 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 806 may process any type of graphics data such as pictures, videos, programs, animation, 3D, 2D, objects images and so forth.

In some embodiments, computing device 805 may include a display controller 808. Display controller 808 may be any type of processor, controller, circuit, logic, and so forth for processing graphics information and displaying the graphics information. The display controller 808 may receive or retrieve graphics information from one or more buffers, such as buffer(s) 220. After processing the information, the display controller 808 may send the graphics information to a display.

In various embodiments, system 800 may include a transceiver 844. Transceiver 844 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. It may also include a transceiver for wired networking which may include (but are not limited to) Ethernet, Packet Optical Networks, (data center) network fabric, etc. In communicating across such networks, transceiver 844 may operate in accordance with one or more applicable standards in any version. The embodiments are not limited in this context.

In various embodiments, computing device 805 may include a display 845. Display 845 may constitute any display device capable of displaying information received from processor circuit 802, graphics processing unit 806 and display controller 808.

In various embodiments, computing device 805 may include storage 846. Storage 846 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 846 may include technology to increase the storage performance enhanced protection for valuable digital media when multiple hard drives are included, for example. Further examples of storage 846 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 805 may include one or more I/O adapters 847. Examples of I/O adapters 847 may include Universal Serial Bus (USB) ports/adapters, IEEE 1394 Firewire ports/adapters, and so forth. The embodiments are not limited in this context.

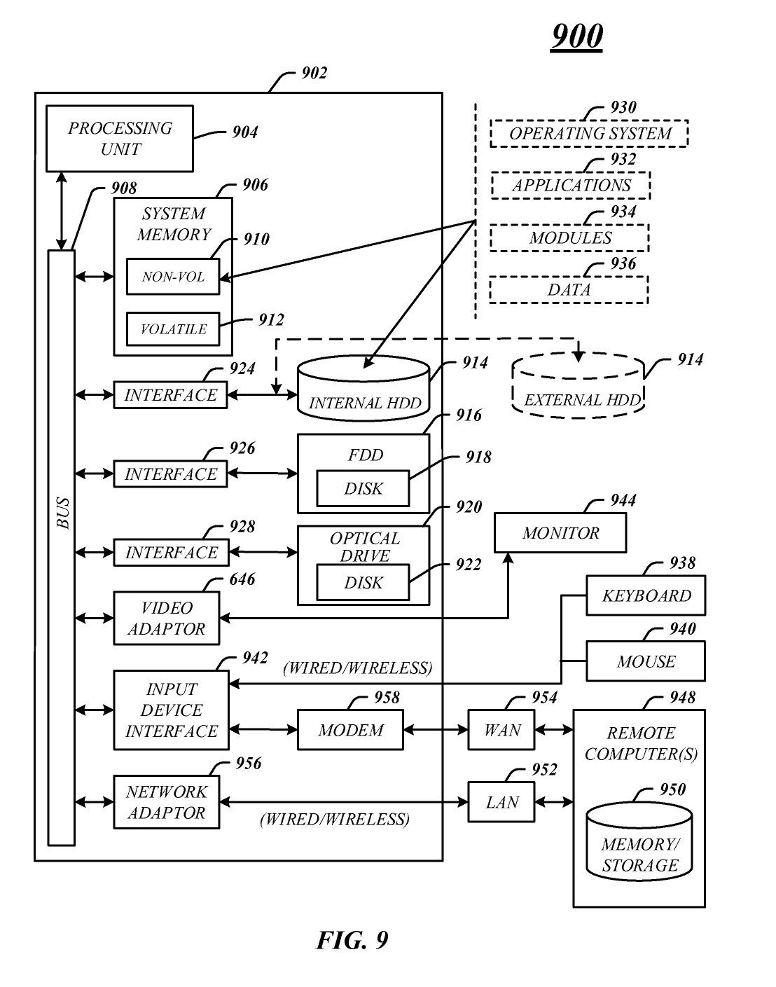

FIG. 9 illustrates an embodiment of an exemplary computing architecture 900 suitable for implementing various embodiments as previously described. In one embodiment, the computing architecture 900 may comprise or be implemented as part of system 100 and computing device 105.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, such as those described with reference to the processor component 102 shown in FIG. 1.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 105.

A user can enter commands and information into the computer 902 through one or more wired/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wired and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements of the computing system 101 and 200 as previously described with reference to FIGS. 1-8 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty-three (1-33) provided below are intended to be exemplary and non-limiting.

In a first example, a system, device, controller, or an apparatus can include a switching circuit, one or more input/output (I/O) ports coupled with the switching circuit, and a switching circuit control component, at least partially implemented in circuit. The switching circuit control component to create an idle period for a processing unit and the switching circuit by enabling buffering of one or more packets in a buffer for the one or more I/O ports, cause the processing unit and/or the switching circuit to operate in a lower power state during the idle period, and cause the processing unit and/or the switching circuit to exit the lower power state by communicating one or more out-of-band messages to the processing unit and/or the switching circuit.

In a second example and in furtherance of the first example, a system, device, controller, or an apparatus can include the switching circuit control component to receive packet information from at least one of the one or more I/O ports, and cause the processing unit and/or the switching circuit to operate in a higher power state based on the packet information.

In a third example and in furtherance of any of the previous examples, a system, device, controller, or an apparatus can include the packet information comprising a number of packets, a priority of packets, or both, and the switching circuit control component to receive the packet information and cause the processing unit and/or the switching circuit to operate in the higher power state prior to a dynamic memory address interrupt.

In a fourth example and in furtherance of any of the previous examples, a system, device, controller, or an apparatus can include the switching circuit control component to send information to the one or more I/O ports indicating the processing unit and/or switching circuit are to enter a lower power state to enable buffering of the one or more packets by the one or more I/O ports.

In a fifth example and in furtherance of any of the previous examples, a system, device, controller, or an apparatus can include the switching circuit control component to communicate the one or more out-of-band messages to the processing unit and/or the switching circuit via a system management bus (SMbus) or an inter-integrated circuit (I2C) bus.

In a sixth example and in furtherance of any of the previous examples, a system, device, controller, or an apparatus can include the switching circuit control component to determine an amount of traffic for each of the one or more I/O ports, and direct one or more packets having a lower priority from a target I/O port having a higher amount of traffic to a different I/O port having a lower amount traffic via the switching circuit.

In a seventh example and in furtherance of any of the previous examples, a system, device, controller, or an apparatus can include the switching circuit control component to direct one or more packets having a higher priority to a target I/O port having a higher amount of traffic via the switching circuit.

In an eighth example and in furtherance of any of the previous examples, a system, device, controller, or an apparatus can include wherein each of the one or more I/O ports is associated with a different buffer, and the switching circuit control component to buffer packets for each of the one or more I/O ports in the associated buffer.

In a ninth example and in furtherance of any of the previous examples, a system, device, controller, or an apparatus can include the processing unit, and a memory to store one or more buffers each associated with a particular one of the one or more I/O ports.

In a tenth example and in furtherance of any of the previous examples, an article comprising a non-transitory computer-readable storage medium comprising a plurality of instructions that when executed enable processing circuitry to create an idle period for a processing unit and a switching circuit by buffering one or more packets in a buffer for one or more input/output (I/O) ports, cause the processing unit and/or the switching circuit to operate in a lower power state during the idle period, and cause the processing unit and/or the switching circuit to exit the lower power state by communicating one or more out-of-band messages to the processing unit and/or the switching circuit.

In a eleventh example and in furtherance of any of the previous examples, an article comprising a non-transitory computer-readable storage medium comprising a plurality of instructions that when executed enable processing circuitry to receive packet information from at least one of the one or more I/O ports, and cause the processing unit and/or the switching circuit to operate in a higher power state based on the packet information.

In a twelfth example and in furtherance of any of the previous examples, an article comprising a non-transitory computer-readable storage medium comprising a plurality of instructions that when executed enable processing circuitry to process the packet information comprising a number of packets, a priority of packets, or both, and the plurality of instructions that when executed enable processing circuitry to receive packet information and cause the processing unit and/or the switching circuit to operate in the higher power state prior to a dynamic memory address interrupt.

In a thirteenth example and in furtherance of any of the previous examples, an article comprising a non-transitory computer-readable storage medium comprising a plurality of instructions that when executed enable processing circuitry to send information to the one or more I/O ports indicating the processing unit and/or switching circuit are to enter a lower power state to enable buffering of the one or more packets by the I/O ports.

In a fourteenth example and in furtherance of any of the previous examples, an article comprising a non-transitory computer-readable storage medium comprising a plurality of instructions that when executed enable processing circuitry to communicate the one or more out-of-band messages to the processing unit and/or the switching circuit via a system management bus (SMbus) or an inter-integrated circuit (I2C) bus.

In a fifteenth example and in furtherance of any of the previous examples, an article comprising a non-transitory computer-readable storage medium comprising a plurality of instructions that when executed enable processing circuitry to determine an amount of traffic for each of the one or more I/O ports, and direct one or more packets having a lower priority from a target I/O port having a higher amount of traffic to a different I/O port having a lower amount traffic via the switching circuit.

In a sixteenth example and in furtherance of any of the previous examples, an article comprising a non-transitory computer-readable storage medium comprising a plurality of instructions that when executed enable processing circuitry to direct one or more packets having a higher priority to a target I/O port having a higher amount of traffic via the switching circuit.

In a seventeenth example and in furtherance of any of the previous examples, an article comprising a non-transitory computer-readable storage medium comprising a plurality of instructions that when executed enable processing circuitry to buffer packets for each of the one or more I/O ports in the associated buffer.

In an eighteenth example and in furtherance of any of the previous examples, a method can include creating an idle period for a processing unit and a switching circuit by buffering one or more packets in a buffer for one or more input/output (I/O) ports, causing the processing unit and/or the switching circuit to operate in a lower power state during the idle period, and causing the processing unit and/or the switching circuit to exit the lower power state by communicating one or more out-of-band messages to the processing unit and/or the switching circuit.

In a nineteenth example and in furtherance of any of the previous examples, a method can include receiving packet information from at least one of the one or more I/O ports, and causing the processing unit and/or the switching circuit to operate in a higher power state based on the packet information.

In a twentieth example and in furtherance of any of the previous examples, a method can include receiving packet information, and causing the processing unit and/or the switching circuit to operate in the higher power state prior to a dynamic memory address interrupt.

In a twenty-first example and in furtherance of any of the previous examples, a method can include sending information to the one or more I/O ports indicating the processing unit and/or switching circuit are entering a lower power state to enable buffering of the one or more packets by the one or more I/O ports.

In a twenty-second example and in furtherance of any of the previous examples, a method can include communicating the one or more out-of-band messages to the processing unit and/or the switching circuit via a system management bus (SMbus) or an inter-integrated circuit (I2C) bus.

In a twenty-third example and in furtherance of any of the previous examples, a method can include determining an amount of traffic for each of the one or more I/O ports, and directing one or more packets having a lower priority from a target I/O port having a higher amount of traffic to a different I/O port having a lower amount traffic via the switching circuit.

In a twenty-fourth example and in furtherance of any of the previous examples, a method can include directing, by the processing circuitry, one or more packets having a higher priority to a target I/O port having a higher amount of traffic via the switching circuit

In a twenty-fifth example and in furtherance of any of the previous examples, a method can include wherein each of the one or more I/O ports is associated with a different buffer, and the method, comprising buffering packets for each of the one or more I/O ports in the associated buffer.

In a twenty-sixth example and in furtherance of any of the previous examples, a apparatus can include means for creating an idle period for a processing unit and a switching circuit by buffering one or more packets in a buffer for one or more input/output (I/O) ports, means for causing the processing unit and/or the switching circuit to operate in a lower power state during the idle period, and means for causing the processing unit and/or the switching circuit to exit the lower power state by communicating one or more out-of-band messages to the processing unit and/or the switching circuit.

In a twenty-seventh example and in furtherance of any of the previous examples, an apparatus can include means for receiving packet information from at least one of the one or more I/O ports, and causing the processing unit and/or the switching circuit to operate in a higher power state based on the packet information.

In a twenty-eighth example and in furtherance of any of the previous examples, an apparatus can include means for receiving packet information, and means for causing the processing unit and/or the switching circuit to operate in the higher power state prior to a dynamic memory address interrupt.

In a twenty-ninth example and in furtherance of any of the previous examples, an apparatus can include means for sending information to the one or more I/O ports indicating the processing unit and/or switching circuit are entering a lower power state to enable buffering of the one or more packets by the one or more I/O ports.

In a thirtieth example and in furtherance of any of the previous examples, an apparatus can include means for communicating the one or more out-of-band messages to the processing unit and/or the switching circuit via a system management bus (SMbus) or an inter-integrated circuit (I2C) bus.

In a thirty-first example and in furtherance of any of the previous examples, an apparatus can include means for determining an amount of traffic for each of the one or more I/O ports, and means for directing one or more packets having a lower priority from a target I/O port having a higher amount of traffic to a different I/O port having a lower amount traffic via the switching circuit.

In a thirty-second example and in furtherance of any of the previous examples, an apparatus can include means for directing one or more packets having a higher priority to a target I/O port having a higher amount of traffic via the switching circuit

In a thirty-third example and in furtherance of any of the previous examples, an apparatus can include wherein each of the one or more I/O ports is associated with a different buffer, and means for buffering packets for each of the one or more I/O ports in the associated buffer.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a switching circuit;
one or more input/output (I/O) ports coupled with the switching circuit;
a switching circuit control component, at least partially implemented in circuitry, to:
create an idle period for a processing unit and the switching circuit by enabling buffering of one or more packets in a buffer for the one or more I/O ports;
cause the processing unit and/or the switching circuit to operate in a lower power state during the idle period; and
cause the processing unit and/or the switching circuit to exit the lower power state by communicating one or more out-of-band messages to the processing unit and/or the switching circuit.

2. The apparatus of claim 1, the switching circuit control component to receive packet information from at least one of the one or more I/O ports, and cause the processing unit and/or the switching circuit to operate in a higher power state based on the packet information.

3. The apparatus of claim 2, the packet information comprising a number of packets, a priority of packets, or both, and the switching circuit control component to receive the packet information and cause the processing unit and/or the switching circuit to operate in the higher power state prior to completion of dynamic memory addressing.

4. The apparatus of claim 1, the switching circuit control component to send information to the one or more I/O ports indicating the processing unit and/or switching circuit are to enter a lower power state to enable buffering of the one or more packets by the one or more I/O ports.

5. The apparatus of claim 1, the switching circuit control component to communicate the one or more out-of-band messages to the processing unit and/or the switching circuit via a system management bus (SMbus) or an inter-integrated circuit (I2C) bus.

6. The apparatus of claim 1, the switching circuit control component to determine an amount of traffic for each of the one or more I/O ports, and direct one or more packets having a lower priority from a target I/O port having a higher amount of traffic to a different I/O port having a lower amount traffic via the switching circuit.

7. The apparatus of claim 6, the switching circuit control component to direct one or more packets having a higher priority to a target I/O port having a higher amount of traffic via the switching circuit.

8. The apparatus of claim 1, wherein each of the one or more I/O ports is associated with a different buffer, and the switching circuit control component to buffer packets for each of the one or more I/O ports in the associated buffer.

9. The apparatus of claim 1, comprising:
the processing unit; and
a memory to store one or more buffers each associated with a particular one of the one or more I/O ports.

10. An article comprising a non-transitory computer-readable storage medium comprising a plurality of instructions that when executed enable processing circuitry to:
create an idle period for a processing unit and a switching circuit by buffering one or more packets in a buffer for one or more input/output (I/O) ports;
cause the processing unit and/or the switching circuit to operate in a lower power state during the idle period; and
cause the processing unit and/or the switching circuit to exit the lower power state by communicating one or more out-of-band messages to the processing unit and/or the switching circuit.

11. The non-transitory computer-readable storage medium of claim 10, further comprising the plurality of instructions that when executed enable processing circuitry to receive packet information from at least one of the one or more I/O ports, and cause the processing unit and/or the switching circuit to operate in a higher power state based on the packet information.

12. The non-transitory computer-readable storage medium of claim 11, the packet information comprising a number of packets, a priority of packets, or both, and the plurality of instructions that when executed enable processing circuitry to receive packet information and cause the processing unit and/or the switching circuit to operate in the higher power state prior to completion of dynamic memory addressing.

13. The non-transitory computer-readable storage medium of claim 10, further comprising the plurality of instructions that when executed enable processing circuitry to send information to the one or more I/O ports indicating the processing unit and/or switching circuit are to enter a lower power state to enable buffering of the one or more packets by the I/O ports.

14. The non-transitory computer-readable storage medium of claim 10, further comprising the plurality of instructions that when executed enable processing circuitry to communicate the one or more out-of-band messages to the processing unit and/or the switching circuit via a system management bus (SMbus) or an inter-integrated circuit (I2C) bus.

15. The non-transitory computer-readable storage medium of claim 10, further comprising the plurality of instructions that when executed enable processing circuitry to determine an amount of traffic for each of the one or more I/O ports, and direct one or more packets having a lower priority from a target I/O port having a higher amount of traffic to a different I/O port having a lower amount traffic via the switching circuit.

16. The non-transitory computer-readable storage medium of claim 10, further comprising the plurality of instructions that when executed enable processing circuitry to direct one or more packets having a higher priority to a target I/O port having a higher amount of traffic via the switching circuit.

17. The non-transitory computer-readable storage medium of claim 10, wherein each of the one or more I/O ports is associated with a different buffer, and the plurality of instructions that when executed enable processing circuitry to buffer packets for each of the one or more I/O ports in the associated buffer.

18. A computer-implemented method, comprising:
creating, by processing circuitry, an idle period for a processing unit and a switching circuit by buffering one or more packets in a buffer for one or more input/output (I/O) ports;
causing, by the processing circuitry, the processing unit and/or the switching circuit to operate in a lower power state during the idle period; and
causing, by the processing circuitry, the processing unit and/or the switching circuit to exit the lower power state by communicating one or more out-of-band messages to the processing unit and/or the switching circuit.

19. The computer-implemented method of claim 18, comprising:
receiving, by the processing circuitry, packet information from at least one of the one or more I/O ports; and
causing, by the processing circuitry, the processing unit and/or the switching circuit to operate in a higher power state based on the packet information.

20. The computer-implemented method of claim 19, packet information comprising a number of packets, a priority of packets, or both, and the method comprising:
receiving, by the processing circuitry, packet information; and
causing, by the processing circuitry, the processing unit and/or the switching circuit to operate in the higher power state prior to completion of dynamic memory addressing.

21. The computer-implemented method of claim 18, comprising:
sending, by the processing circuitry, information to the one or more I/O ports indicating the processing unit and/or switching circuit are entering a lower power state to enable buffering of the one or more packets by the one or more I/O ports.

22. The computer-implemented method of claim 18, comprising:
communicating, by the processing circuitry, the one or more out-of-band messages to the processing unit and/or the switching circuit via a system management bus (SMbus) or an inter-integrated circuit (I2C) bus.

23. The computer-implemented method of claim 18, comprising:
determining, by the processing circuitry, an amount of traffic for each of the one or more I/O ports; and
directing, by the processing circuitry, one or more packets having a lower priority from a target I/O port having a higher amount of traffic to a different I/O port having a lower amount traffic via the switching circuit.

24. The computer-implemented method of claim 18, comprising:
directing, by the processing circuitry, one or more packets having a higher priority to a target I/O port having a higher amount of traffic via the switching circuit.

25. The computer-implemented method of claim 18, wherein each of the one or more I/O ports is associated with a different buffer, and the method, comprising:
buffering packets for each of the one or more I/O ports in the associated buffer.
